(19) United States
(12) Patent Application Publication
(10) Pub. No.: US 2013/0093765 A1
(43) Pub. Date: Apr. 18, 2013

(54) Method for Rapidly Changing Scenes in a Virtual Environment

(71) Applicants: Thomas Buchauer, Zirndorf (DE); Theresa Anne Kinney-Johnson, Dallas, TX (US)

(72) Inventors: Thomas Buchauer, Zirndorf (DE); Theresa Anne Kinney-Johnson, Dallas, TX (US)

(21) Appl. No.: 13/652,400

(22) Filed: Oct. 15, 2012

Related U.S. Application Data
(60) Provisional application No. 61/546,583, filed on Oct. 13, 2011.

(51) Int. Cl. G06T 15/00

(52) U.S. Cl. 345/419

(57) ABSTRACT

A method by which virtual scenes comprising buildings, landscapes, scene-specific items, and other environmental elements are made readily available to display to a user, and incorporate his or her avatar within the scene established within an accessible region, wherein a scene may be applied to multiple regions upon purchase through a virtual marketplace. The method is enacted via a secured server computer, which performs the processes required to change the scene of a region rapidly, and communicate the changes to a user experiencing the scene via a computer,

### CONTINUITY DATA

This is a non-provisional application of provisional patent application No. 61/546,583, filed on Oct. 13, 2011, and priority is claimed thereto.

### FIELD OF THE PRESENT INVENTION

The present invention relates to virtual environments, and more specifically socially connected online, virtual worlds maintaining the capacity to display and provide for an online society, hosted on a system of secured server computers. It is the intent of the present invention to facilitate the remapping of landscapes, buildings, tools, and other environmental objects or elements nearly instantaneously from within a virtual world, with minimal clicks or input from the user.

### BACKGROUND OF THE PRESENT INVENTION

At the advent of 3D virtual worlds in the 1990s, users began to experience the joys of escaping to virtual worlds. As online communities grew with more members signing up daily, the societal infrastructure of the online worlds continued to grow as well. Commerce systems and currencies were introduced, enabling users to purchase land, items, machinery, vehicles, or indeed, anything that could be rendered in 3D virtually through software. A user's character, known conventionally as an avatar, can travel anywhere in the virtual world that he or she is granted permission to. In the past, transportation was often comparable to real world transportation, in that a user would require a conventional means to travel from one portion of a virtual world to another. For example, users could instruct their avatar to walk, ride in a vehicle, fly in a plane, and in later versions, fly or hover their avatar at a rapid pace to a new destination. In some simulations, users may be granted the capacity to ‘fly’ or hover their avatar faster as an effective and fun method of virtual transportation. Transportation such as this adds to the unity of the virtual world, and gives other landscapes time to load prior to the arrival of the user's avatar at the new location.

Conventionally, users acquire or are granted access to a region within the virtual world, which includes the user's land. The region is physically stored on a secured computer server, and in reality, the region is simply dedicated server space that the user has access to. The user may then place buildings, landscape elements such as trees, roads, weather, and other environmental elements onto the region of land, such that the user achieves a different overall experience. In some virtual environments, each user's region is isolated from the regions of others. As an alternative to traveling to other regions for a change of scenery, or rather, to make better use of the land and region a user already maintains access to, users may alter the region as they see fit. For example, users may place a forest over large areas of his or her region when in the mood for a relaxing simulated getaway. Similarly, users may wish to employ an environment with a business setup and conference room to conduct business in virtually within his or her region. These environmental parameters consisting of objects and environmental conditions are similar to a ‘skin’ on a region, and are conventionally titled ‘scenes.’

Unfortunately, there is often not a rapid means of adapting a region (changing scenes) within a virtual world rapidly, on-the-fly at the whim of the user. In some simulated environments, the scene must be manually rebuilt for each use, or the user must maintain multiple regions in order to maintain independent scenes within each region if he or she wishes to access each scene rapidly. Conventionally, time is lost when a user wishes to change the environment within his or her own region. Additionally, occasionally some of the exclusive or nicer scenes are built from scratch.

Thus, there is a need for a method for rapidly changing between scenes within a user's region in a virtual world that is capable of minimizing time loss, maximizing efficiency, and maintaining consistency of ownership through scenes in a given region such that all states of the environment are saved upon assignment of a scene or un-assignment of a scene seamlessly.

### SUMMARY OF THE PRESENT INVENTION

The present invention is a method that allows a user in a virtual world to change the current displayed Scene (e.g. Landscape, Buildings, Tools, and other environmental elements) with a simple mouse click—without the need to own multiple regions—on demand. For example: a user may start the day on a single region in its virtual environment with a recreational scene, utilize the process of the present invention to ‘Hotswap’ it out for a conference scene for a business meeting at afternoon, and then employ the process of the present invention again later to enjoy a concert at a club scene at night, all from within the same region accessible to a user within a virtual 3D environment.

The process of the present invention is embedded in a digital marketplace, and thus, additional scenes must be purchased in order to access their content within a region the user has access to. It is the intent of the present invention to enable users to easily switch between accessible scenes within a 3D virtual world, within an accessible region.

### BRIEF DESCRIPTION OF THE DRAWINGS

FIG. 1 displays a basic flow chart representing the primary process of the preferred embodiment of the present invention.

FIG. 2 is a flow chart highlighting the scene selection and purchasing process via a marketplace.

FIG. 3 exhibits a flow chart displaying implementation of the process of the present invention after scenes are purchased or available via the hotswap Control Panel.

FIG. 4 shows an example dialog screen that exhibits the assigning and selection of a scene from the Control Panel (220).

FIG. 5 displays a visual reference of the difference between a region and a scene.

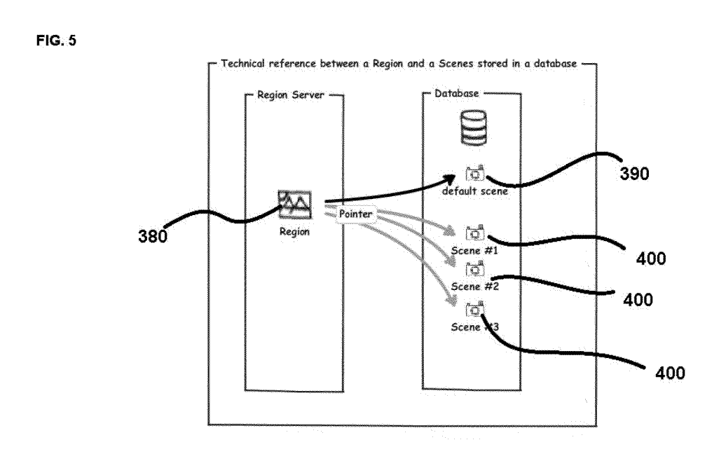

FIG. 6 shows a visual representation of assigning multiple scenes to different regions.

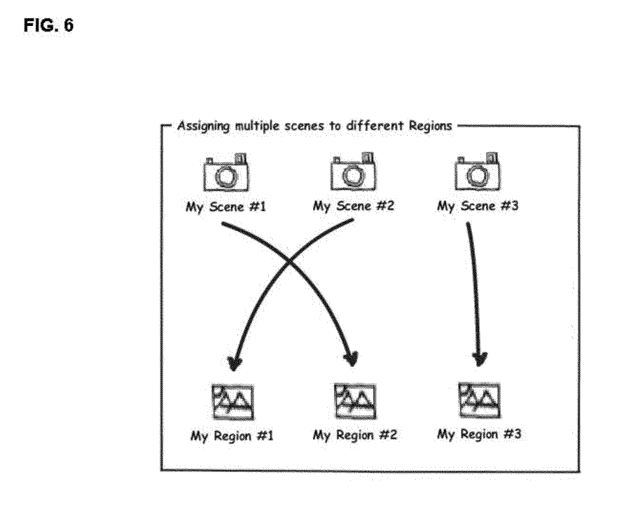

FIG. 7 outlines the methods to assign and un-assign a scene from or to a region.

### DETAILED DESCRIPTION OF THE PREFERRED EMBODIMENT

The following are a list of terms used in the detailed description:
HotSwap: Short term for the invention title Simulation: Simulation is the imitation of some real thing, state of affairs, or process. The act of simulating something generally entails representing certain key characteristics or behaviours of a selected physical or abstract system.
Virtual World: A virtual world is an online community that often takes the form of a computer-based simulated environment through which users can interact with one another and use and create objects. The term has become largely synonymous with interactive 3D virtual environments, where the users take the form of avatars visible to others. These avatars usually appear as textual, two-dimensional, or three-dimensional representations, although other forms are possible.
Virtual Land: A user can own virtual land in a virtual world. Optically it's a simulation of real land you can own, technically it is reserved computer (server) capacity the user has access to.
User: Interacts with a scene that is displayed (delivered) from a Region.
Scene: Digital definition of a virtual environment, stored in a database, that defines landscape, buildings & tools that are displayed and allows users to interact with.
Region: Process on a physical server with software that is able to display a scene (virtual environment). A User can own a Region (preserved computing capacity).
Simulator, Simulation: Term for combined Region & Scene
Control Panel (220): A User interface (web page) that visualizes the technical backend and provides interaction to it
Digital marketplace (210): A web based shopping portal for digital (virtual) goods e.g. https://spotonsynergy.com
Grid: Combines many Simulator's into a virtual world. Scene bucket: A location where references of the Scenes from the marketplace are stored (e.g. in a database)
Scene Description File (OAR): A (XML) file that contains the complete digital description of a scene (also the binaries). Typically, these OAR files are an export of the existing open source “OpenSimulator” distribution from an existing Scene.
Viewer: An application that provides access to a virtual world and displays a simulation that runs on a region (380) that runs a specific Scene.

The method of the preferred embodiment of the present invention begins with obtaining a scene from a digital marketplace or any other source (10). The digital marketplace (210) provides a list of scenes for sale (300). The list of scenes for sale (300) may include thumbnails or full images as samples of what the scene (400) would look like upon assignment to a region (380). During this first step, the computer ensures that the user maintains a valid subscription with a payment provider (e.g. PayPal) that allows the use of HotSwap method of the present invention. If the user has an active subscription, the user is provided access to the digital marketplace (210). The digital marketplace (210) is the virtual location where users may purchase scenes (400) and other content. Users obtain scenes from a digital marketplace (210) or any other source (10). From there, users may browse a list of available scenes (400) for purchase, or attain select other scenes (400) for free. Users use the control panel to manage scenes (20). From the control panel (220), users may either assign a scene to a region (30), or unassign a scene from a region (40). This is called hotswapping a scene (400).

After obtaining one or more scenes (400), preferably via a digital marketplace (210), the scenes (400) are stored in the user's personal HotSwap Account, accessible via the control panel (220). Many of the account options, including funds storage for marketplace purchases, can be accessed at any time by the user from within the Control Panel (220). The Control Panel (220) is accessible either via the web (200) or through a desktop application (210). Additionally, the Control Panel (220) is accessed, by the user, in order to assign a scene (30) or un-assign a scene (40) from or two a specified region (380). A user preferably uses the Assign button (230) to assign a scene to a region (380) from within the control panel (220). After the user selects an action, the method of the present invention will execute, and load the selected scene for the user to experience within the accessible region (380).

### Managing Scenes and Performing HotSwap

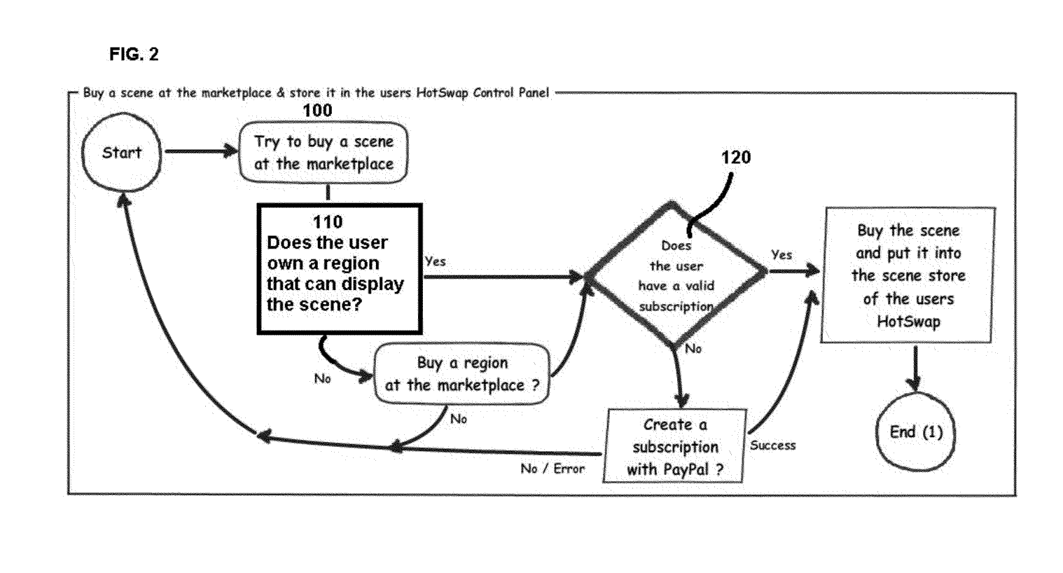

FIG. 2 displays how a user may buy a scene (400) at the marketplace and store it in the user's HotSwap Control Panel (220). The user can access the Control Panel (220) either from a website or from an application (e.g. Viewer). The Control Panel (220) allows the user to manage all of the owned Scenes (400) (assign, un-assign them to region(s) or delete them). After choosing an action the method will execute. The Control Panel (220) takes care about the limits of the Region(s) the user owns.

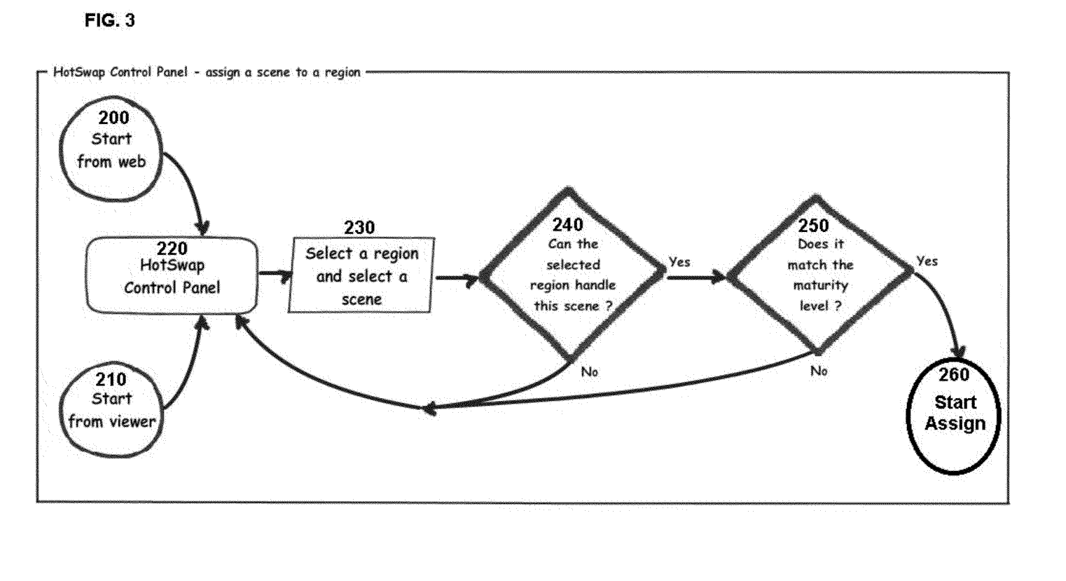

Limits on scene (400) selection may include maturity ratings, size of a Scene (400) (in bytes) compared to allowed size of a Region, and other capacity factors. For example, in maturity ratings: if a user is a minor and a Region is accessible to minors, but the selected scene (400) contains adult content, the assignment of the scene (400) to the region would be denied. The user may also assign multiple scenes (400) to different regions (FIG. 3.)

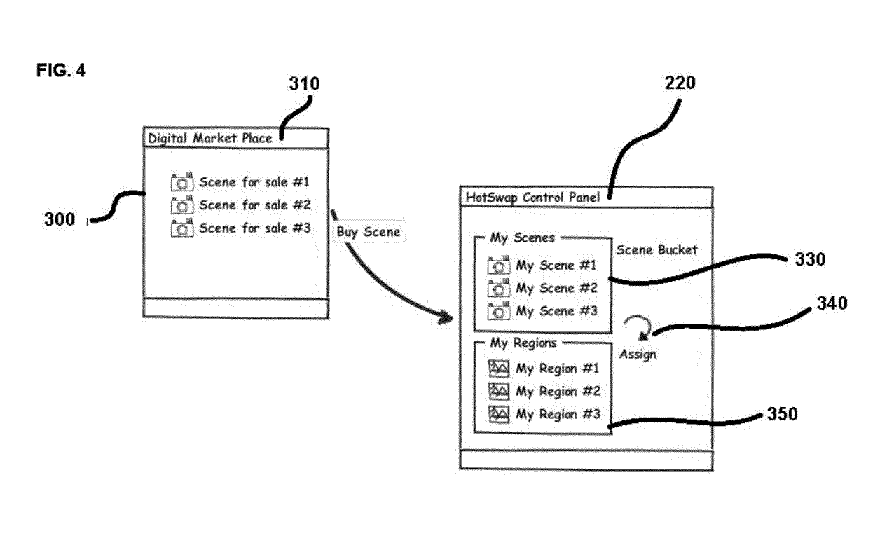

The method of the present invention begins when a user visits a digital marketplace (210) and tries to buy a Scene (100), as seen in FIG. 2. The method of the present invention will check if the user owns a region (380) and that it supports this scene (400). If not, it will prompt the user to buy/get a region (380) that can handle this scene (400). Then the method will check if the user has a valid subscription to use HotSwap. If not, it will prompt the user to get a subscription. After this, the user may purchase the scene (400) or acquire it for free. The scene (400) will then be store in the user's personal HotSwap scene bucket (320), as seen in FIG. 4. The user will then be taken to the Control Panel (220) to manage the newly acquired scene (400), as well as associate it with an existing Region(s) (380).

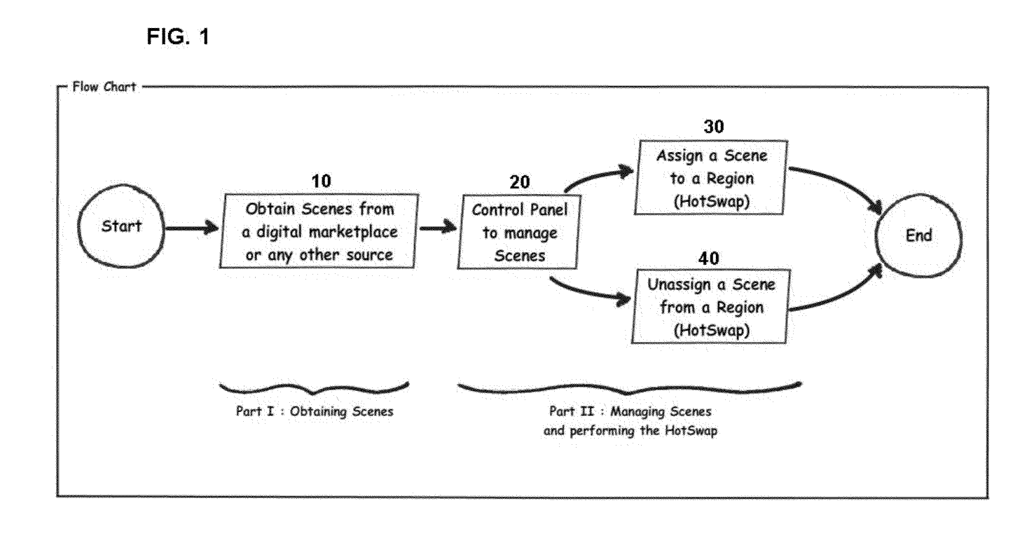

The present invention functions, preferably in accordance with the procedure outlined in FIG. 1. Here, it is seen that the user accesses the Control Panel (220) from the web or from an application (e.g. Viewer). Next, the user selects a scene (400) to assign to a Region owned. The method will then preferably check if the scene (400) matches the requirements to run on this Region. If the Scene (400) does not match the requirements, then the request will be denied, and the hotswap will be unsuccessful. The method of the present invention will then check if the maturity level will match the destination Region. In the event that the maturity level does not match the destination region, assignment of the scene (400) to the region (380) will be denied. Additionally, the method of the present invention will check other dependencies that may vary according to the specific region, scene (400), or hardware capabilities. If everything is permissible as declared by the server, then the reference between the Region and the Scene (400) will be changed (FIG. 2.) and the HotSwap will start.(FIG. 4.) If a user owns more then one Region, it is possible to assign different scenes (400) to different regions (380) at the same time.

The first picture shows the technical method how a scene (400) is assigned to a Region. When a scene (400) is assigned to a region, it effectively stops the current simulation, and, if the scene (400) is loading for the first time, a new region will be created for the scene (400) while simultaneously loading an OAR scene description file. The method of the present invention will then change the ‘pointers’ in the database to utilize this scene (400), rather than the default for the region. The method of the present invention will then reinitialize the region again for the user.

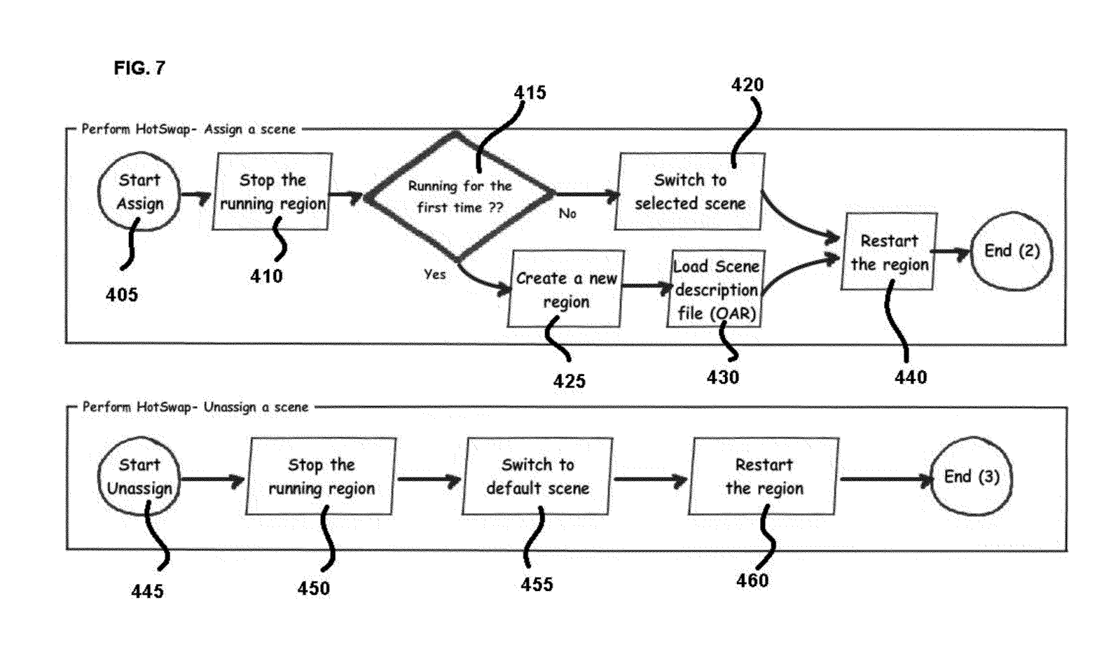

FIG. 7 illustrates how to assign a scene (30) and un-assign a scene (40). When the process of assigning a scene (30) begins, a cue is issued to stop the running region, as seen in FIG. 7. The ‘pointer’ in the database will be directed to the user's default region, which is then restored from a database in the process of un-assigning a scene (40).

In order to initialize a scene, the method of the present invention employs a process which preferably runs on a secured central server, connected to the internet, and secured by conventional means. The secured server executes the process of hotswapping a scene, thereby changing any or all environmental elements presented within a given virtual region. This is preferably performed by the secured server computer in under a minute, as not to detract from the flow of the experience for the user.

When the process of the present invention begins, it begins by stopping the currently running region, as seen in FIG. 7. If the new scene (400) is running for the first time, a new Region will be created for this scene (400), while loading an OAR Scene description file. The method of the present invention will then change the pointers in the database to use this newly selected scene (400). The method of the present invention then will restart the region, such that it loads with the new scene.

The second portion of FIG. 7 illustrates how to un-assign a Scene (40). When the process of un-assigning a scene begins, the selected region (380) will be stopped. The POINTER to it's default region (380) will be employed in order to restore the default scene (390) from a database. The method of the present invention will restart the region (380) with its default Scene (390). The scene (400) is then available for other HotSwap instances in the future, as it is saved on the server as purchased for later use.

It is to be understood that the method of the present invention is enacted via a secured server computer, which performs the processes required to change the scene of a region (380) rapidly, and communicate the changes to a user experiencing the scene via a computer.

In essence, the present invention enables a user to rapidly change between scenes (400) within a the user's region(s) (380) in a virtual world in such a way that time lost is minimized, efficiency is maximized, and consistency of ownership is maintained through scenes in a given region such that all states of the environment are saved upon assignment of a scene or un-assignment of a scene seamlessly.

An additional feature of the present invention is that scenes (400) may be sized according to the space provided by the region (380). For example, a scene (400) may contain a total of five links, such as stores or buildings, each with explorable internal environments. In larger, conventionally more expensive regions (380) which the user has purchased more database space, the collection of stores will preferably be spaced apart such that they occupy the entirety of the region, regardless of the region's size. Extra space will preferably be evident between the stores (links) which will be occupied by extended filler, such as digitally rendered grass, sidewalks, roads, etc.

It should be understood that someone skilled in the art is knowledgeable about the creation of a scene and assigning it or mapping it to a region. Overall, the manipulation of scenes is known, however the manner by which the present invention changes scenes is novel.

Alternate embodiments of the present invention include the present invention maintaining the ability to save preset scenes based on a user's preferences, and assigning scenes based on a specific cue, such as a specified time or action within the scene. These are optional features that could be exhibited by an alternate or enhanced version of the present invention. Similarly, automated scene assignment could be facilitated after the user has purchased the scene and confirmed that it is compliant with the target region (380) it is to be displayed on. Likewise, multiple scenes (400) may be assigned to multiple regions (380) automatically as well with conventional automation techniques. For example, the process of the present invention may be automated such that a scene (400) could be assigned to a region (380) at a user-defined time. Thus, a dining hall scene (400) could be assigned at dinner time, a conference room scene (400) could be assigned at 3:00 p.m. etc. It should be understood that only one scene may be assigned to any one region (380) at any given time.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

It should therefore be understood that the present invention is a method for changing scenes by a user within a digital world comprising the computer displaying a region (380), the computer providing a control panel within the region (380), the user purchasing a first scene (400) from a digital marketplace, the computer checking for compatibility between the first scene (400) and the region (380), the computer assigning the first scene (400) to the region (380), the computer loading all environmental conditions and appearance of the region (380) according to parameters and objects dictated by the first scene (400), and the computer restarting the region (380) with the assigned scene (400). The computer performs these tasks through the use of memory stored on a conventional database and executes the assignment of scenes (400) via a secured server computer. Additionally, the computer verifies that the first scene (400) is age-appropriate for the user prior to assigning the scene (400) to the region (380). Conversely, the computer may also unassign the first scene (400) from the region (380) prior to the computer assigning a second scene (400) to the region (380). This is the essence of what it is to ‘hotswap’ scene (400). The purchase of scene (400) by a user is only permitted by the computer when the user has a valid payment account. This is verified with a brief check of the user's online credentials and/or profile, which is often incorporated with or assigned to the user's avatar. The user may also acquire scene (400) from other sources other than the digital marketplace. The computer provides a control panel within the region (380) which provides the user with the capacity to switch between the first scene (400) and the second scene without reassigning links within the first scene (400) and the second scene. By this, it is meant that the links are saved, and may be reloaded at a later time upon reassignment of the scene (400). The computer assigning the first scene (400) to the region (380) is performed such that the spacing between and/or within the links are sized according to the size of the region (380) the scene (400) is assigned to. Additionally, the process of the present invention may be automated according to a user defined parameter such as a time of day trigger or elapsed duration.

We claim:

1. A method for changing scenes by a user within a digital world comprising:
the computer displaying a region;
the computer providing a control panel within the region;
purchasing a first scene from a digital marketplace;
the computer checking for compatibility between the first scene and the region;
the computer assigning the first scene to the region;
the computer loading all environment conditions and appearance of the region according to parameters and objects dictated by the first scene; and
the computer restarting the region.

2. The method of claim 1, further comprising the computer verifying that the first scene is age-appropriate for the user.

3. The method of claim 1, further comprising:
the computer unassigning the first scene from the region prior to the computer assigning a second scene to the region.

4. The method of claim 1, wherein purchasing a scene from a digital marketplace is permitted only when the user has a valid payment account.

5. The method of claim 1, further comprising the user acquiring scenes from other sources.

6. The method of claim 3, wherein said the computer providing a control panel within the region allows the user to switch between the first scene and the second scene without reassigning links within the first scene and the second scene.

7. The method of claim 1, wherein said the computer assigning the first scene to the region further comprises the computer applying a template for the first scene to the region such that space between links in the template varies according to size of the region.

8. The method of claim 3, wherein said the computer unassigning the first scene from the region prior to the computer assigning a second scene to the region is automated according to a user-defined parameter.

9. The method of claim 8, wherein the user-defined parameter is a time of day.

10. The method of claim 2, further comprising:
the computer unassigning the first scene from the region prior to the computer assigning a second scene to the region.

11. The method of claim 2, wherein purchasing a scene from a digital marketplace is permitted only when the user has a valid payment account.
